(19) United States
(12) Patent Application Publication
(10) Pub. No.: US 2007/0130064 A1
(43) Pub. Date: Jun. 7, 2007

(54) Construction loan process system and method

(76) Inventor: David V. Strauss, Houston, TX (US)

Correspondence Address: AKIN, GUMP, STRAUSS, HAUER & FELD, 1111 LOUISIANA STREET, 44TH FLOOR, HOUSTON, TX, 77002, US

(21) Appl. No.: 11/295,738

(22) Filed: Dec. 6, 2005

(51) Int. Cl. G06Q 40/00

(52) U.S. Cl. 705/39

(57) ABSTRACT

A method of controlling fund distribution for a project contract. A funds source is provided for distribution by a funds control manager pursuant to a funds control agreement. Requests for payment are analyzed pursuant to the finds control agreement and funds are distributed according to the project contract.

### CROSS-REFERENCE TO RELATED APPLICATIONS

Not applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

This invention relates to financial management systems and, more specifically, to funds control methodology that may be utilized in loan administration including incremental funding based on work activities in process, and for increasing the probability of the successful and profitable completion of construction projects.

2. Description of the Related Art

The commercial lending, construction and development sector of the U.S. economy, including the construction industry, has been wrought with conflicting goals and objectives. Historically, each entity involved in the construction industry operates independently with little regard to the problems that disruptions in the flow of funds has during the course of the typical construction project. The financial institutions, governmental entities, owners, sureties, contractors, sub-contractors, suppliers, etc. euin the construction industry have typically engaged in schemes that amount to nothing more that pure and simple “gamesmanship” to delay or preclude payments to a contracting party, the results of which are the project delays, cost over-runs, financial losses, contractor and sub-contractor defaults, bankruptcies and resulting lawsuits now inherent in the industry. For example, the Surety Loss Ratio (percentage of claims paid out divided by premium revenue), which varies widely from time to time was 25.3% in 1997 and 18.4% in 1998. These percentages are not insignificant and in 1998 was determined to be $247.8 million. Approximately 70% of these loses were unpaid bills.

A text book example of the above-referenced problems is the Houston construction crash of the mid to late 80's. At that time there were a significant number of contractor and subcontractor defaults. Once default occurs, surety companies traditionally hire a replacement contractor to complete a defaulted contractor's work. However in that time period there were few viable contractors available. Therefore, surety claims consultants would coordinate project completion using the work force of the defaulted contractor. In order to maintain tight financial controls, the surety had the consultants establish a project specific bank account. This account, dubbed a funds control account, was used to receive and disburse project funds for appropriate project expenses therefore preventing funds from being diverted for non-project purposes. In many cases this after-the-fact approach did little to eliminate or mitigate the problems noted above.

On any specific construction project, the uneven ebb and flow of contract funds generally results in two financial situations. One situation is when contract funds exceed the then currently due costs, and the second situation is when contract costs exceed the then currently available funds. In accounting terms these situations are referred to as Billings in Excess of Costs and Costs in Excess of Billings respectively, also commonly referred to as Overbillings and Underbillings.

These predictable shortfalls generally occur at two critical times as the construction project progresses. The first shortfall occurs at the beginning of a project when a contractor begins or mobilizes, the project. Funds are required to mobilize a project prior to sufficient funding being received from the project owner or lender. Often a second shortfall occurs once the construction process is complete as the contractor is closing out the final paperwork on a project as he awaits receipt of final funding. In some construction contracts the project owner or lender will advance funds to the contractor to fund the initial working capital requirements. This is referred to as a contract mobilization advance. In a situation when a lender is lending less than 100% of the funds necessary for construction, some lenders will require the borrower to fund his portion of the project prior to the lender providing funds.

Both of these situations are problematic and typically wrought with abuse. In the former, the contractor might simply take the money and run. In the latter, the borrower and contractor might conspire to circumvent the lender's requirement by falsely inflating the construction contract in order to create the illusion that the borrower made his required investment prior to the lender beginning to fund construction.

The aforementioned results from, and is exacerbated by, what has become a “dance” in which the parties engage in a money shell game. Some would even say it is an American tradition within the development, construction, and related surety and financial community.

By way of further description, circumstances relating to how many finds are paid vary but in summary the traditional scenario will be detailed below. At the beginning of each project the contractor and owner, in conjunction with construction lender, negotiate a mutually acceptable Schedule of Values. The schedule of values presents a detailed breakdown of work activities and their respective monetary value. Utilizing this schedule, project payment will be made.

The owner, many times through his representative architect or engineer, have the objective to arrange the schedule of values in a manner which will provide the contractor minimally ample funding. In this way project bills can be paid, while maintaining an ample remaining balance to complete the project should the contractor fail to do so.

The owner also prefers a contractor to have some level of his own working capital invested in the job as an incentive to properly complete the project. Or another way to say this is that the owner desires to provide the contractor a disincentive to perform poor workmanship or to abandoned the project. The owner/developer has the added incentive of minimizing the amount of funds advanced to contractor, as there is a direct reduction in the loan interest expense.

Conversely, the contractor's objective for the Schedule of Values is to overstate cost values for items of work performed early in the project. Additionally, similar to the owner and/or lender, the contractor prefers to use the owner's money rather than his own working capital. Or, another way to say this is that the contractor desires to provide the owner a disincentive to be difficult to work with, or an incentive for the owner to accept the contractor's quality workmanship.

Resulting from the coupling of a front-ended schedule of values and the natural delay in payables maturing (or being paid late by the contractor) the result is the creation of Billings in Excess of Costs which the contractor may use, or misuse. The contractor should create cost reserves for future Costs in Excess of Billings that will predictably occur later in the project. However, traditionally, the funds are directed or misdirected by the owner/developer or contractor, for purposes outside the subject project such as working capital to start other projects, or to cover costs or losses on other projects, or to cover Costs in Excess of Billings on other projects, or, as is common, diverted for personal uses.

The above scenario is generally wrought with potential abuse by the owners and contractors alike. The end result is one in which project cash flow results are traumatic due to the varying levels of Costs in Excess of Billings and Billings in Excess of Costs.

Accordingly, if a funds control process was instituted from the beginning of the project, before a contractor or sub-contractor gets into financial trouble, such a process would provide reasonable assurance to sureties that project funds would be applied to project obligations and not diverted for other non-project related purposes. This also benefits lenders, project owners and others with a vested interest. The claimed subject matter addresses the problems noted above by providing such funds control processes.

### BRIEF SUMMARY OF THE INVENTION

The claimed subject matter is a funds control and administration related financial management system and process in which the objectives of all parties are simply but effectively aligned and managed resulting in a smooth, beneficial and predictable result for all interested parties. Of importance is that this is achieved without losing any of the normal and traditional roles, responsibilities, duties and obligations of any of the parties.

The claimed subject matter may be utilized in any application involving a loan or funding source, particularly where incremental funding of an activity is based on the completion of tasks or defined milestones. For example, a company may obtain a loan to purchase computer hardware, software, and training for an owner. In accordance with the claimed subject matter payments may be established for payment to the company on the basis of the company's hardware, software, and training deliverables to the owner. Furthermore, staged or lump-sum payments under the loan or funding source may be administered so that distributions to the company upon completing certain milestones, e.g., computer hardware and software installations, the completion of operator training, and system acceptance by the owner.

One preferred embodiment of the claimed subject matter directed at the construction industry is referred to herein as the “Harmony Construction Loan Process™.” A series of activities, including the development of a funds control process or construction escrow and a contract mobilization loan guarantee process, comprises the Harmony Construction Loan Process. An element of the claimed subject matter comprises the Funds Control Process. The Funds Control Process is managed by a Funds Control Manager pursuant to a Funds Control Agreement. The lender, owner and contractor enter into the Funds Control Agreement wherein the control of the distribution of a construction fund is abdicated to and controlled by the Funds Control Manager. In one embodiment of the claimed subject matter, a Funds Control Agreement comprises:
instructions presenting that all contract funds are to be directed to pay contract obligations and not diverted to non-contract purposes;
instructions regarding the payment of contractor overhead and profit;
instruction regarding priorities of payment. For example, first to repay Ample Available Loan if any, second to valid subcontractors or venders on the project, third to establish reserves for disputes, forth to contractor for overhead an profit, etc.;
any other appropriate instructions regarding the project required to maintain control of the funds, and to manage the financial requirements of the project; and
a mechanism assuring that all contract and loan finds are subject to the funds control process.

It should be evident to one skilled in the art that in the claimed subject matter, the funds are controlled pursuant to the Funds Control Agreement. While the point of control can take any number of forms, in a preferred embodiment, the Funds Control Manager is appointed pursuant to an Irrevocable Letter of Directive.

Furthermore, another element of the system and process according to the claimed subject matter, is the provision of Ample Funds to ensure the availability at all times during the construction process to provide for any and all short falls of cash as the ebb and flow of the project cash flow. For example these funds could come from the project construction loan or any other source.

### BRIEF DESCRIPTION OF THE SEVERAL VIEWS OF THE DRAWINGS

FIG. “1” is a graphic presentation of a Typical Construction Related Financial Management process;

FIG. “2” is a graphic presentation of a Typical Project Cash Flow;

FIG. “3” is a graphic presentation of an embodiment of the Harmony Construction Loan Process;

FIG. “4A-4FF” are an embodiment of a Funds Control Agreement;

FIG. “5” is a graphic representation of an embodiment of the claimed subject matter, and when funds control and ample available funds are added; and

FIG. “6” is a graphic presentation of project cash flow utilizing the claimed subject matter.

### DETAILED DESCRIPTION OF THE INVENTION

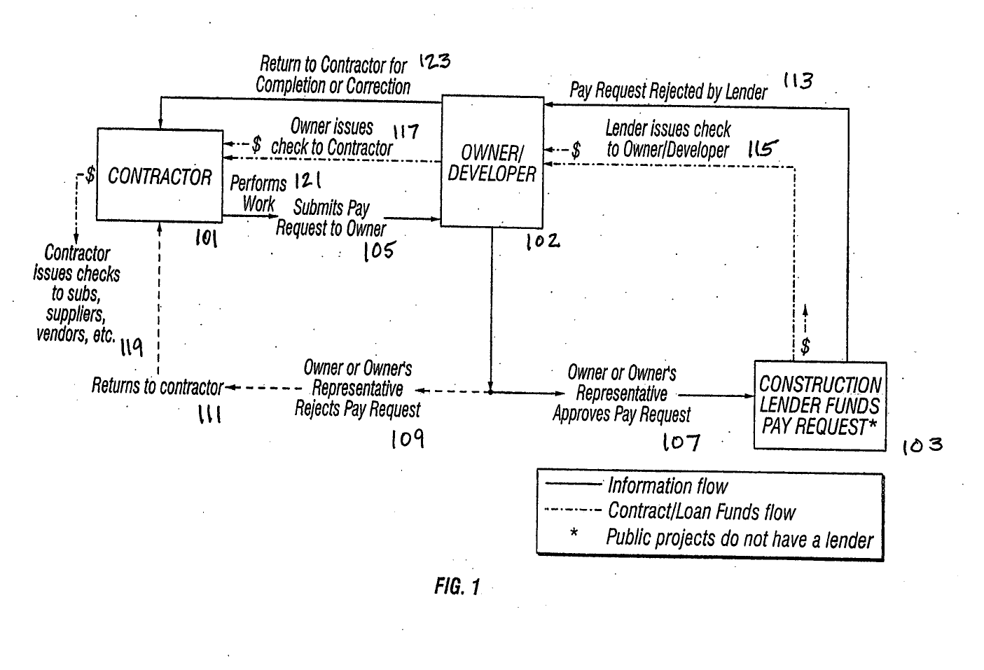

Heretofore, the traditional construction project execution was accomplished according to the process and procedures outlined in FIG. 1. Typically, in response to a Request for Proposal, the Contractor 101 would submit a bid to the Owner/Developer 102. The Owner/Developer would then use the bid to obtain a loan from the Lender 103.

Referring again to FIG. 1, once the construction project is funded by the Lender 103, the Contractor 101 would be engaged to begin performing under a Construction Contract. In order to be paid for the work performed 121, the Contractor 101 submits a Pay Request 105 to the Owner 102 for payment. The Pay Request 105 is evaluated by the Owner 102 or the Owner's Representative who will either approve 107 or reject 109 the request. If the request is rejected, it will be returned to the Contractor 101 to correct any deficiencies 111. If the Pay Request is approved, it is then submitted to the Lender 103 for evaluation and payment. Similarly, the Lender 103 evaluates the Pay Request and will either approve or reject it. If the Pay Request is rejected 113, then it is returned 123 to the Owner 102 to correct the deficiencies. If the Pay Request is approved 107 by the Lender 103, then the Lender 103 will issue a payment 115 to the Owner 102. The Owner 102 will then transmit a payment 117 to the Contractor 101 for the work performed pursuant to the Pay Request. The Contractor 101 is then responsible for issuing payments to subcontractors, suppliers, venders, etc. 119. As noted above, this system is not without problems associated with inappropriate payments, payments used for non-project purposes, and delays associated with the typical project cash flow.

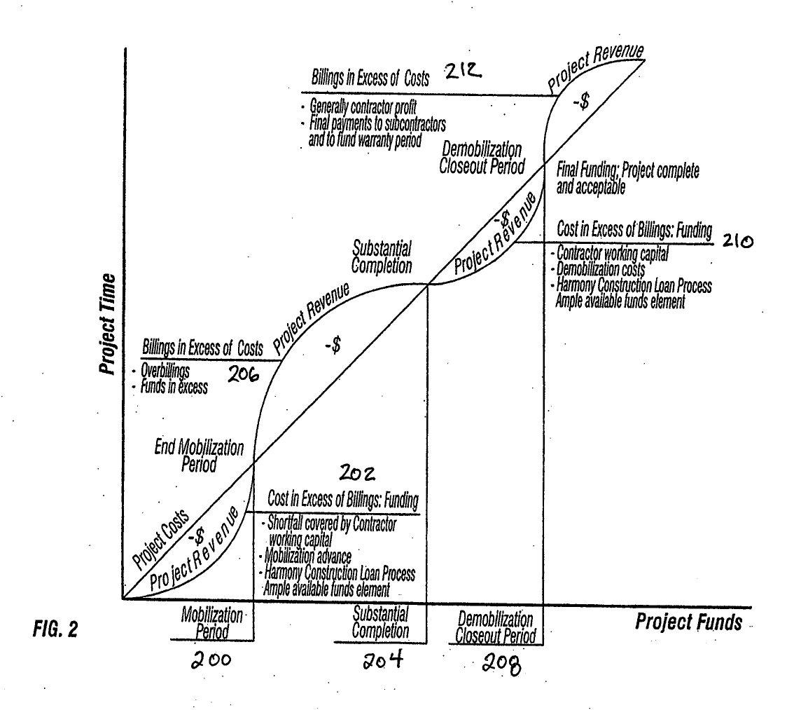

With reference to FIG. 2, the Typical Project Cash Flow is illustrated. During the mobilization period 200, the Contractor experiences Cost in Excess of Billings 202. These shortfalls are traditionally to be covered by the Contractor's own prior available working capital generated from the successful completion of other jobs or as is often times the case, from funds diverted from other projects. As an alternative, some contractors have engaged other lending sources to obtain mobilization loans in order to finance the mobilization of the project. Generally speaking, the mobilization of a project does not comprise reimbursable costs within the scope of the construction loan proceeds.

With further reference to FIG. 2, as the project progresses towards substantial completion 204, the Contractor begins to experience Billings in Excess of Costs 206. This may result from overbillings, the distribution of funds in excess of the Contractor's cost to perform the work, and from costs associated with subcontracted work.

With further reference to FIG. 2, after substantial completion of the project, the Construction Project moves toward completion and the demobilization 208 and close out period begins. During this time the Contractor again experiences Cost in Excess of Billings 210 which requires alternative funding. This funding is again typically provided. by the Contractor's own prior available working capital or the demobilization cost may be funded in a separate loan. Finally, once the project has been completed and accepted by the Owner, the Contractor experiences Billings in Excess of Cost 212, i.e., presumably profiting from the project after final payment to subcontractors and after setting aside funds to cover warranties.

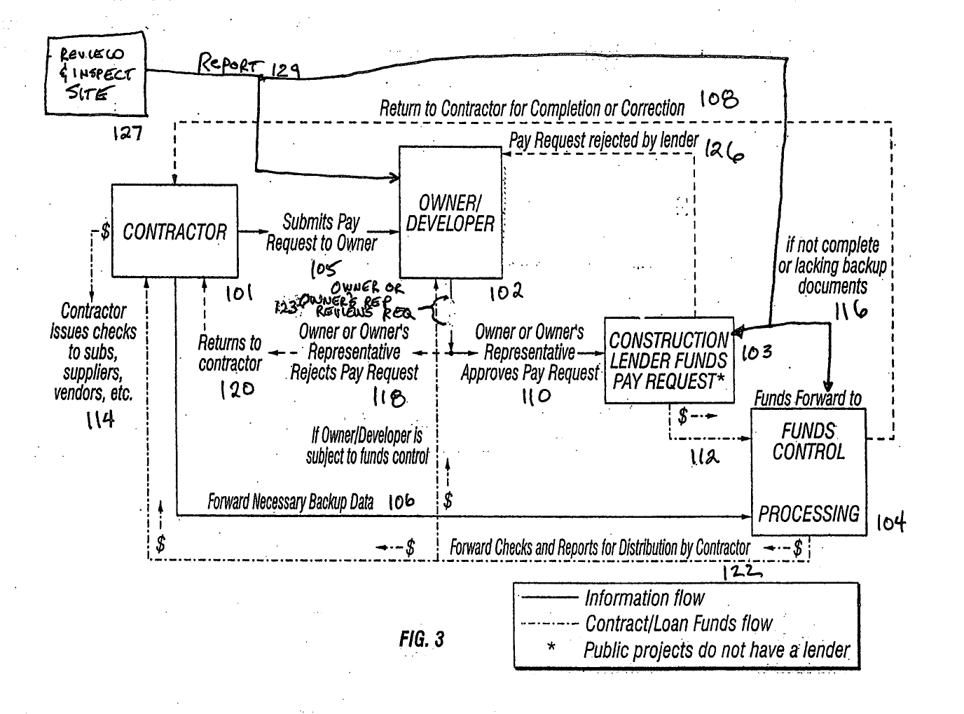

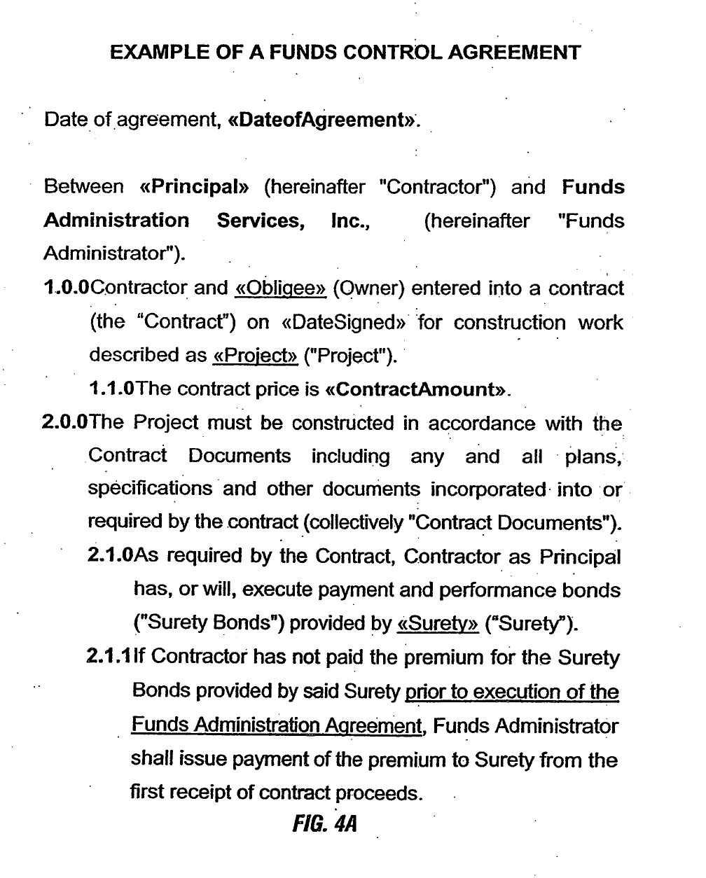

The typically Project Cash flow scenario illustrated in FIG. 2 has been the source of the financial and project construction difficulties described above. The Harmony Construction Loan Process of the claimed subject matter can eliminate the Billings in Excess of Costs and Costs in Excess of Billings so as to insure ample available funds through the course of the construction project. Key elements of the preferred embodiment of the claimed subject matter are described in FIGS. 3-6 below.

With reference to FIG. 3, the preferred embodiment of the claimed subject matter, the Harmony Construction Loan Process, is illustrated to identify the flow of information and funds between the Contractor 101, Owner 102, Construction Lender 103 and Funds Control Administrator 104. It will be evident to one skilled in the art that this process as illustrated in FIG. 3, is implemented after the Construction Contract has been awarded to a Contractor 101, the project is funded by a Lender 103 (or from a source of funds) and after the parties have entered into a Funds Control Agreement. One skilled in the art will also readily recognize that the Funds Control Administrator 104 may be independent, or under the control of any other party, e.g., the lender, surety, borrower, or contractor without departing from the scope of the claimed subject matter.

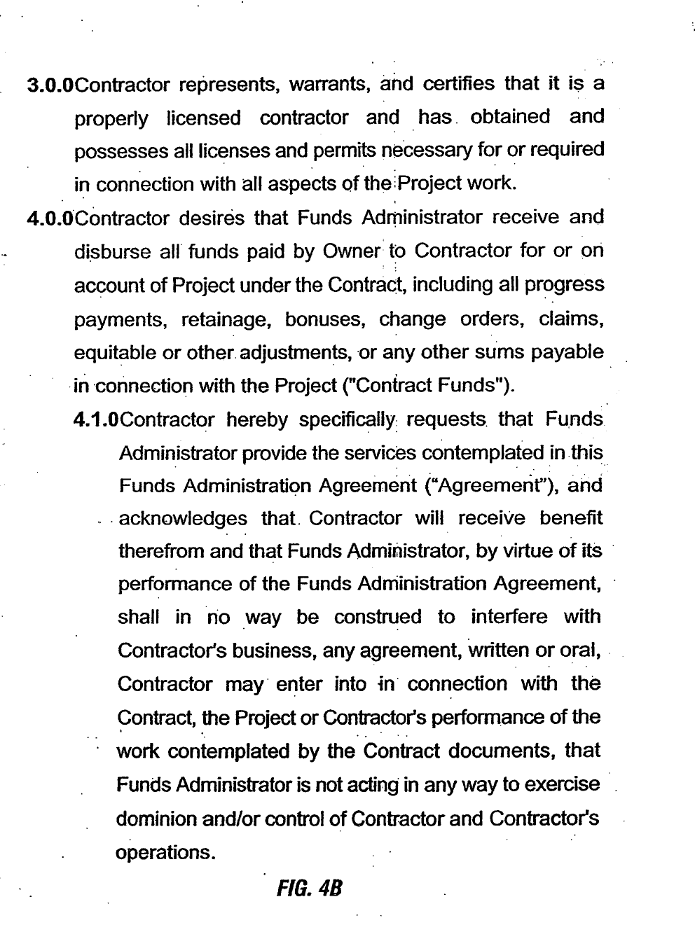

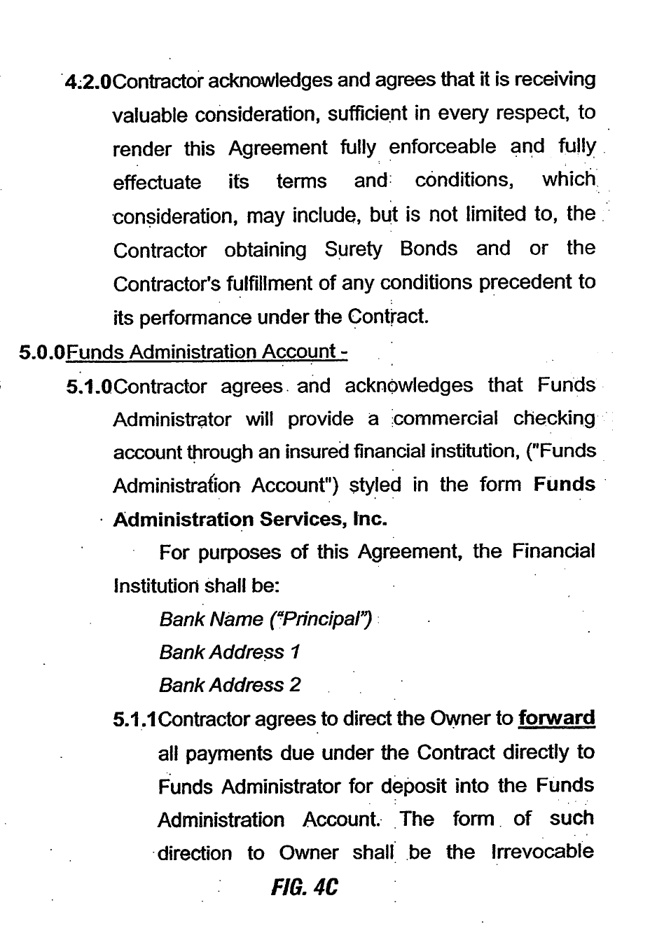

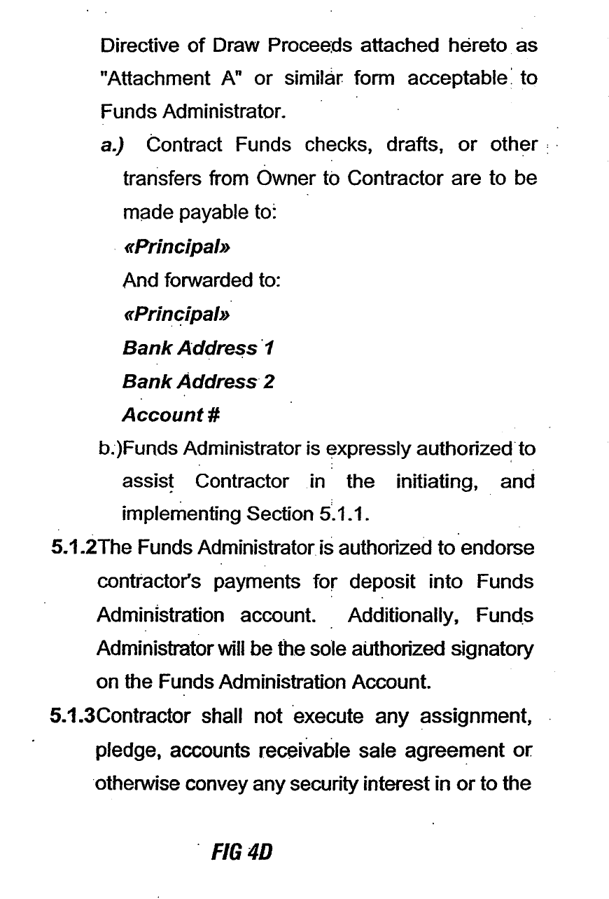

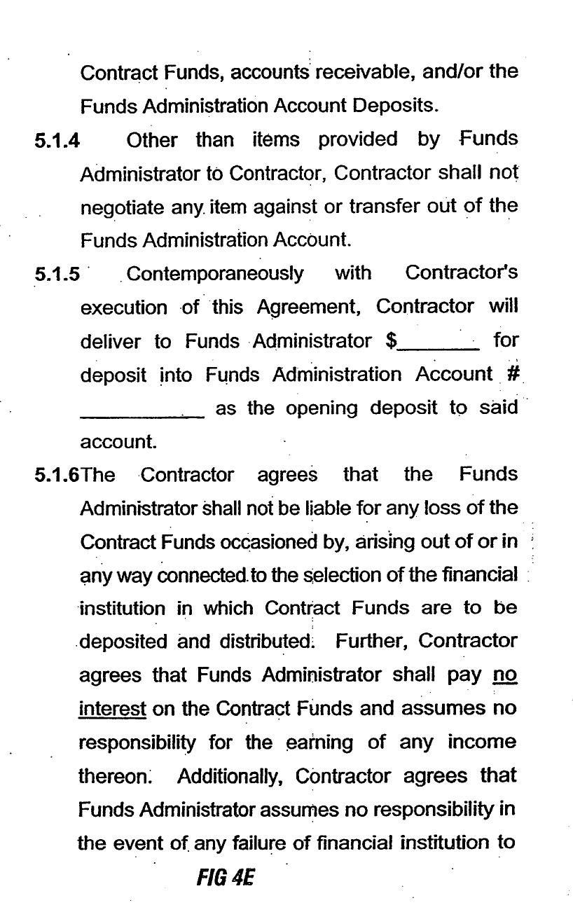

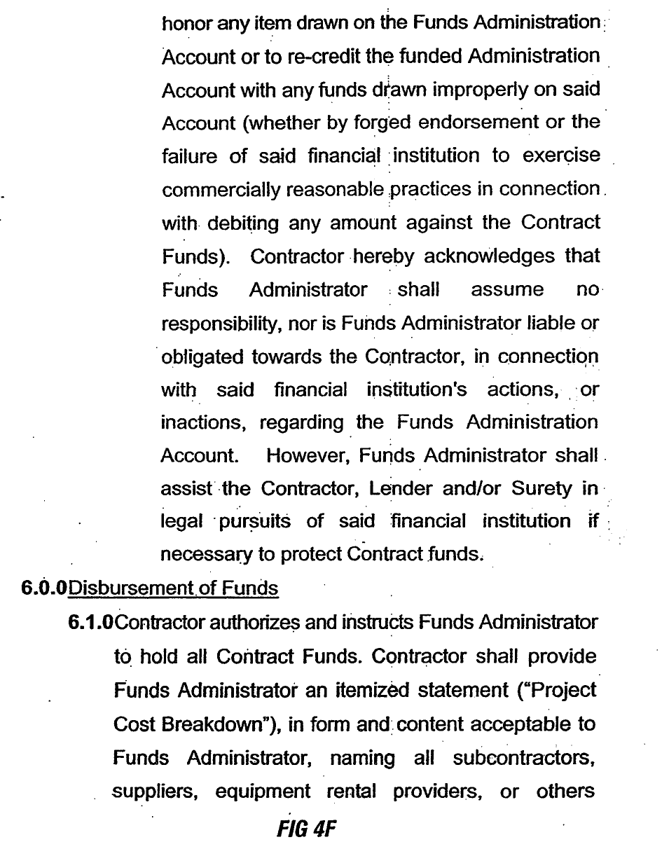

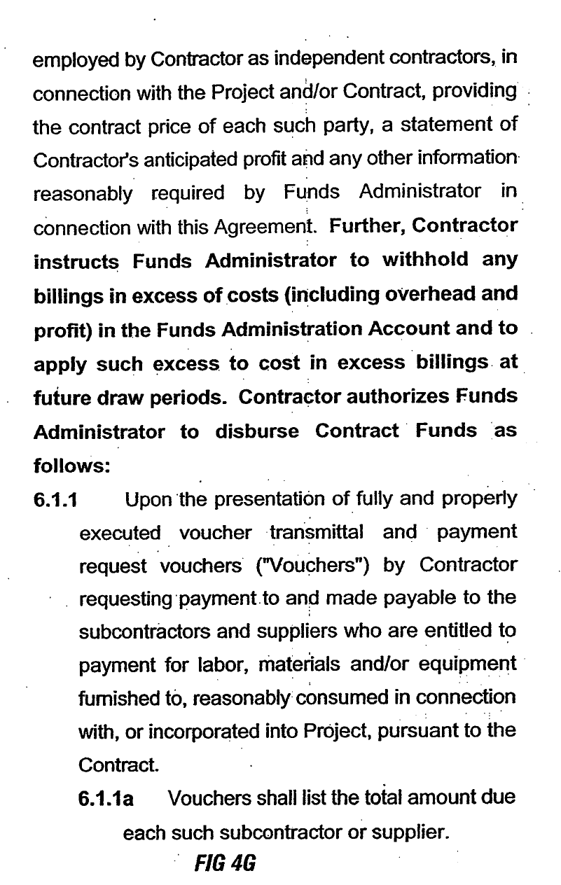

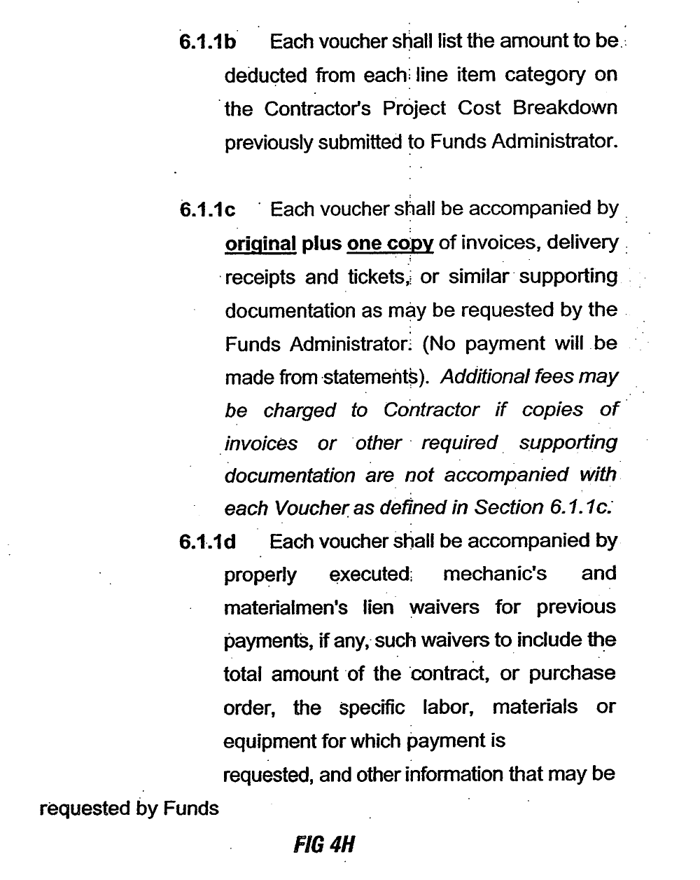

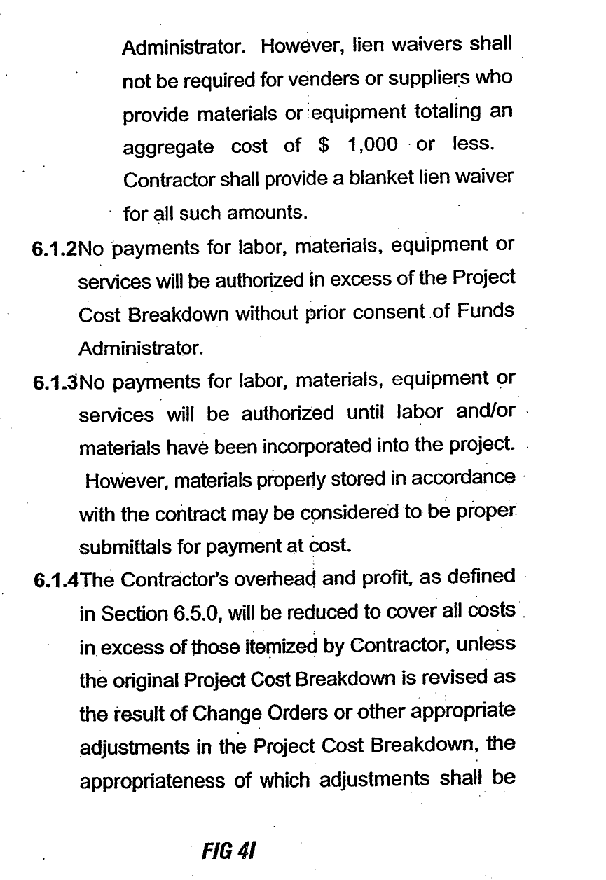

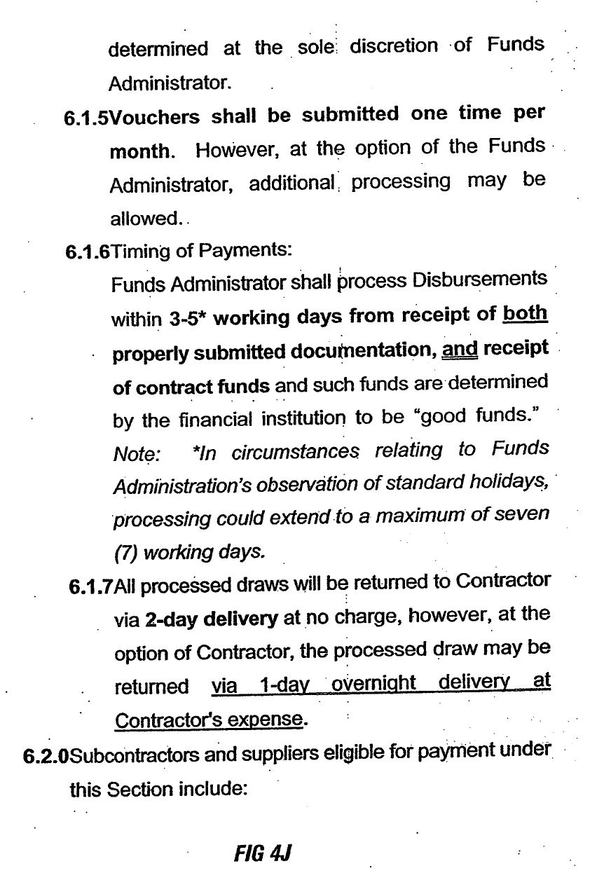

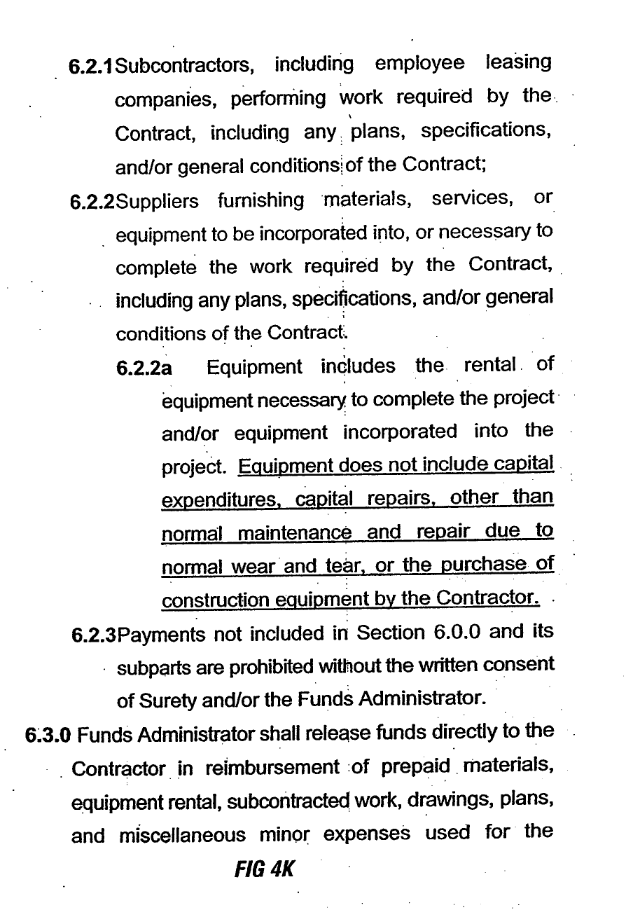

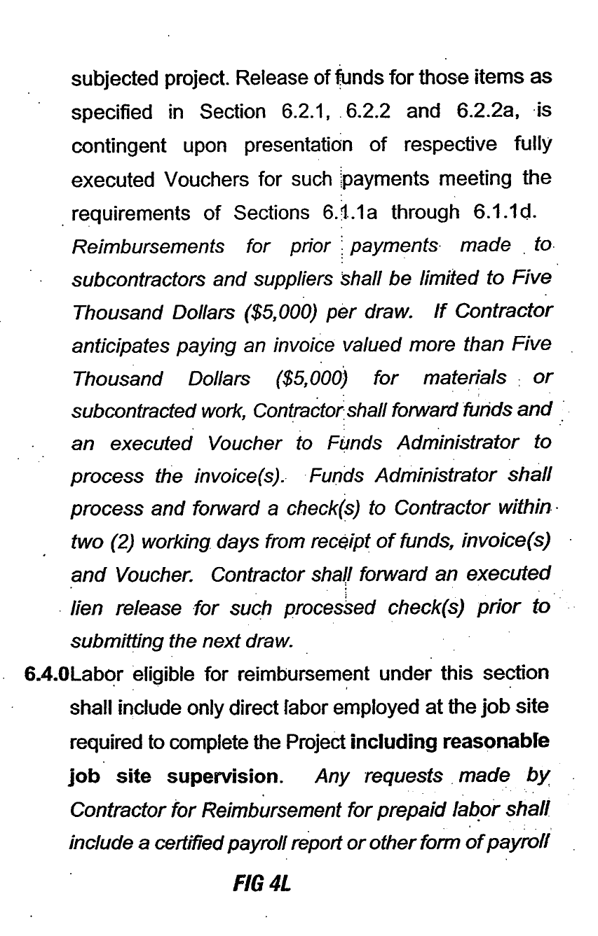

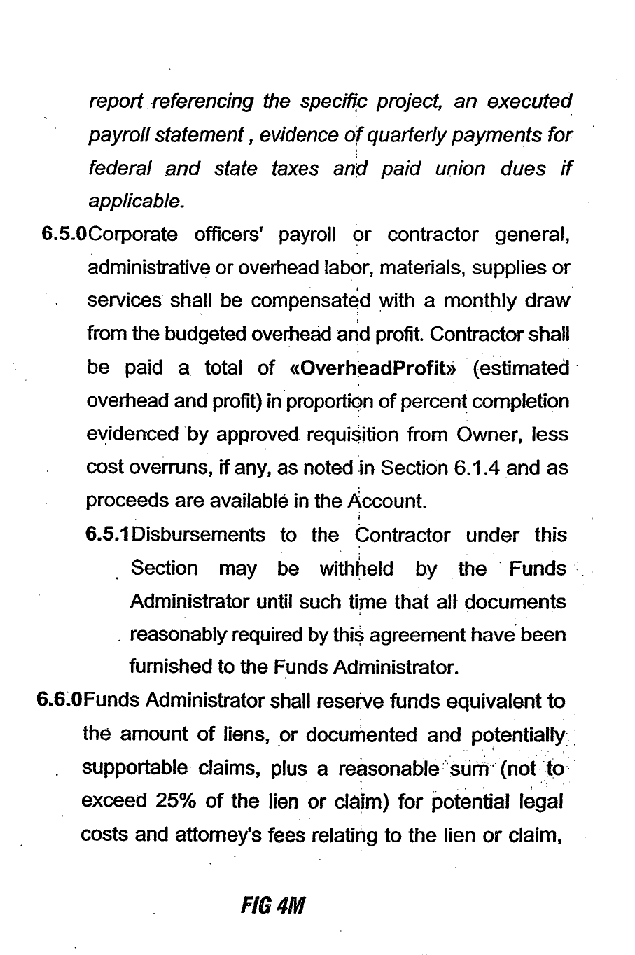

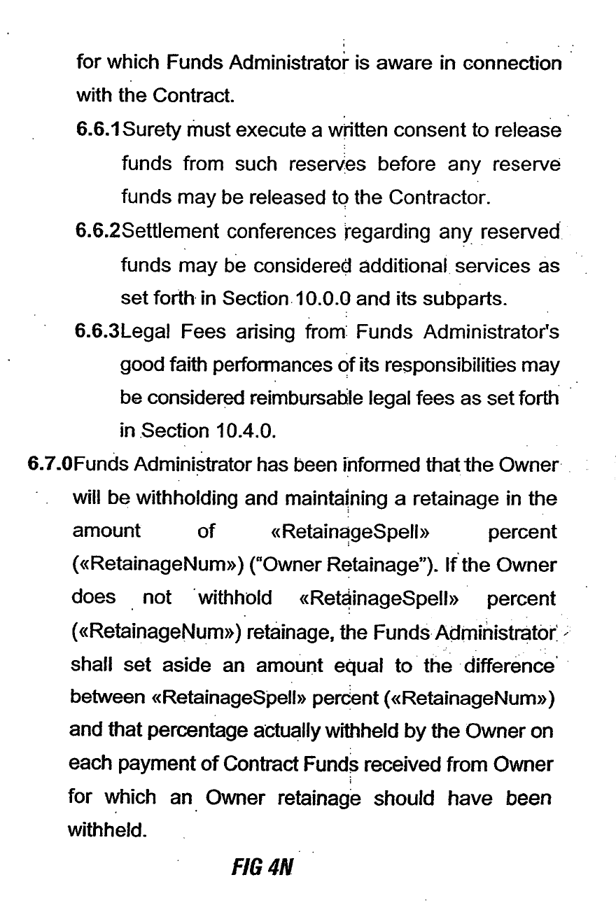

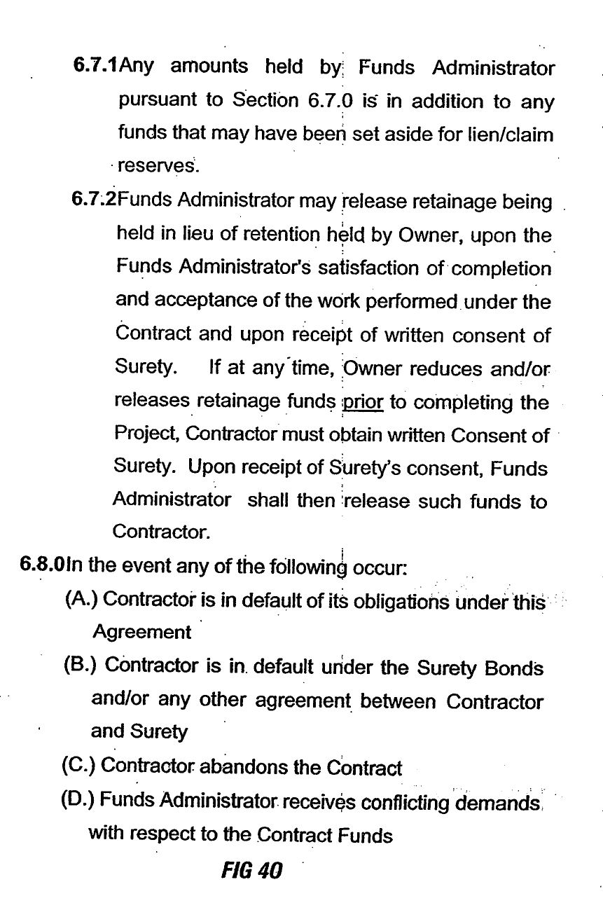

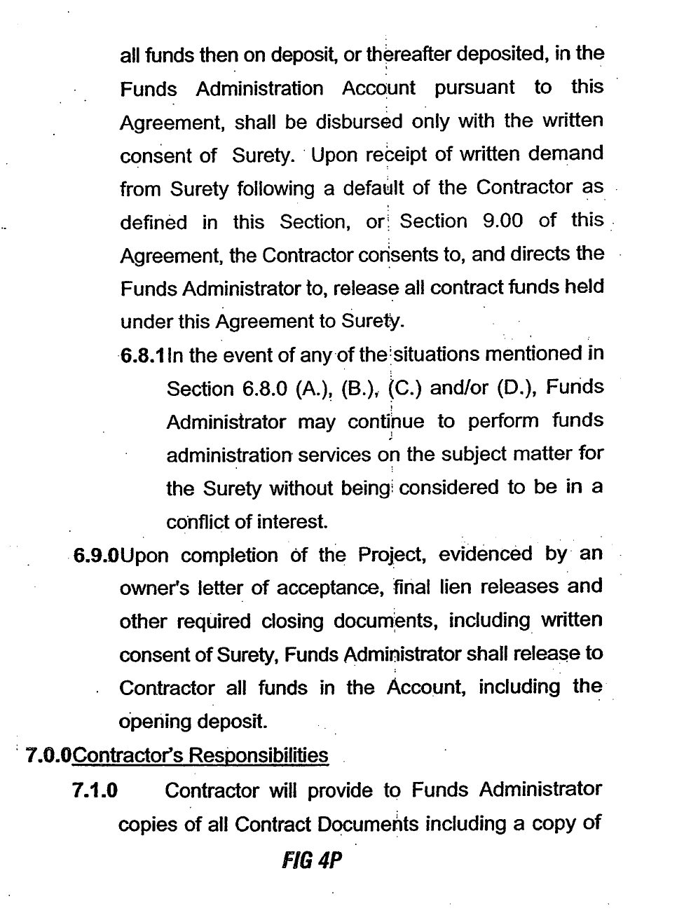

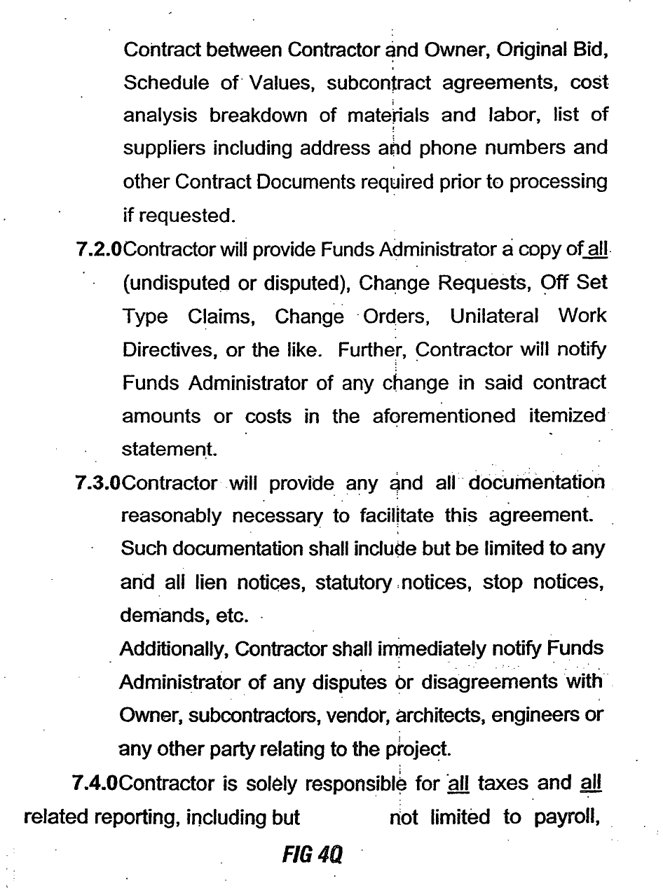

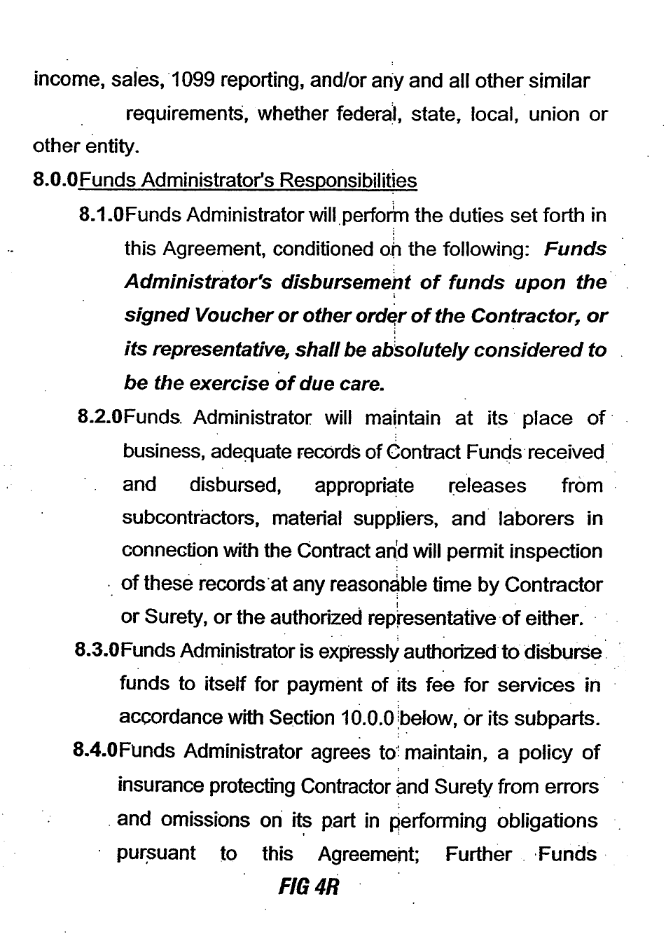

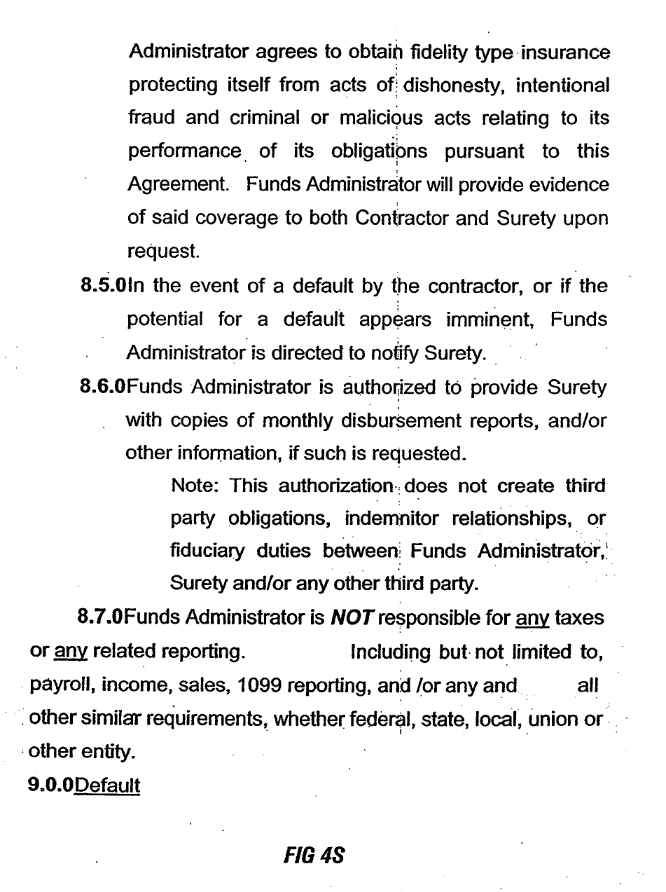

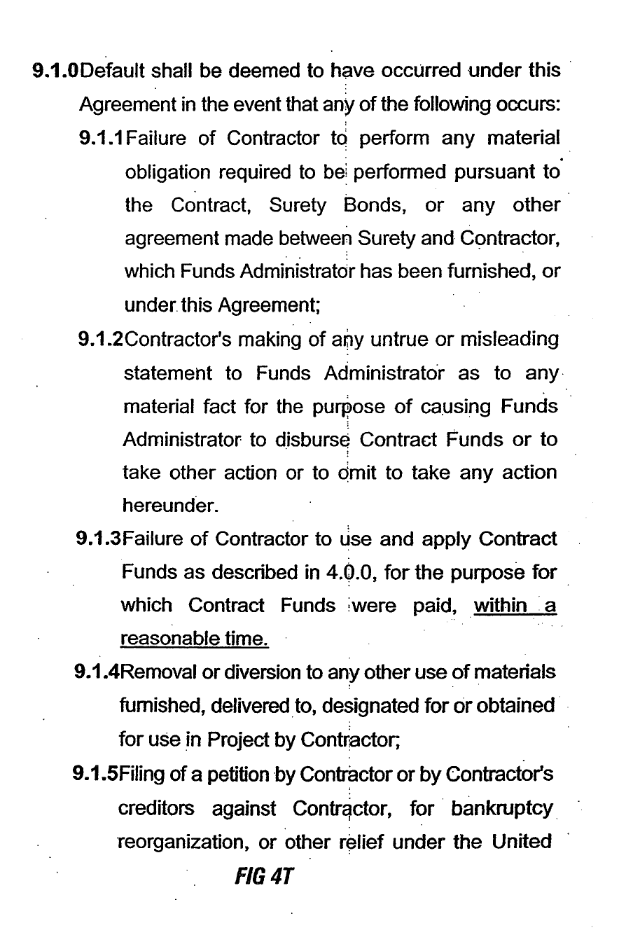

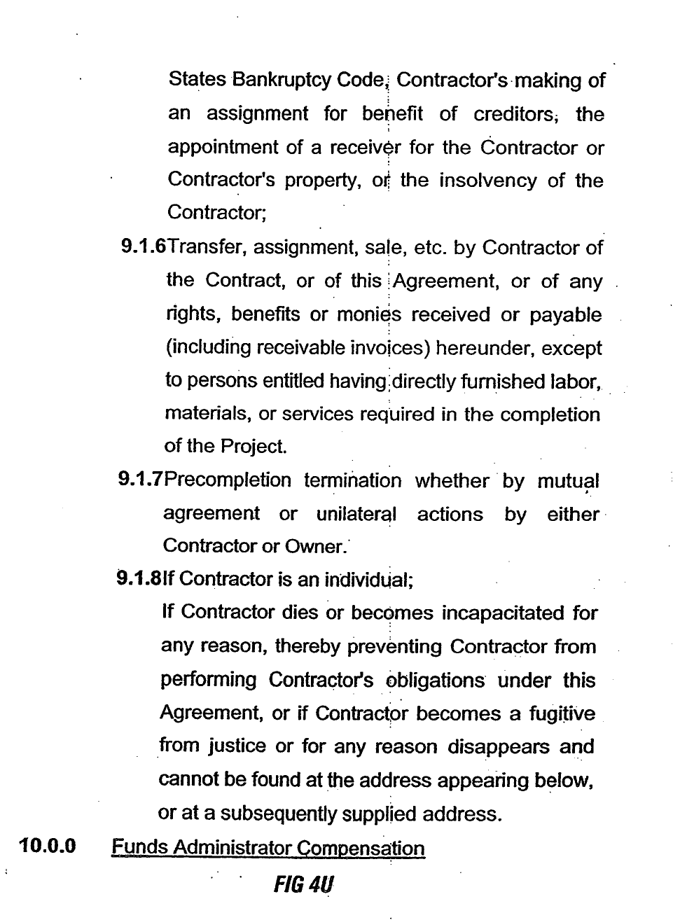

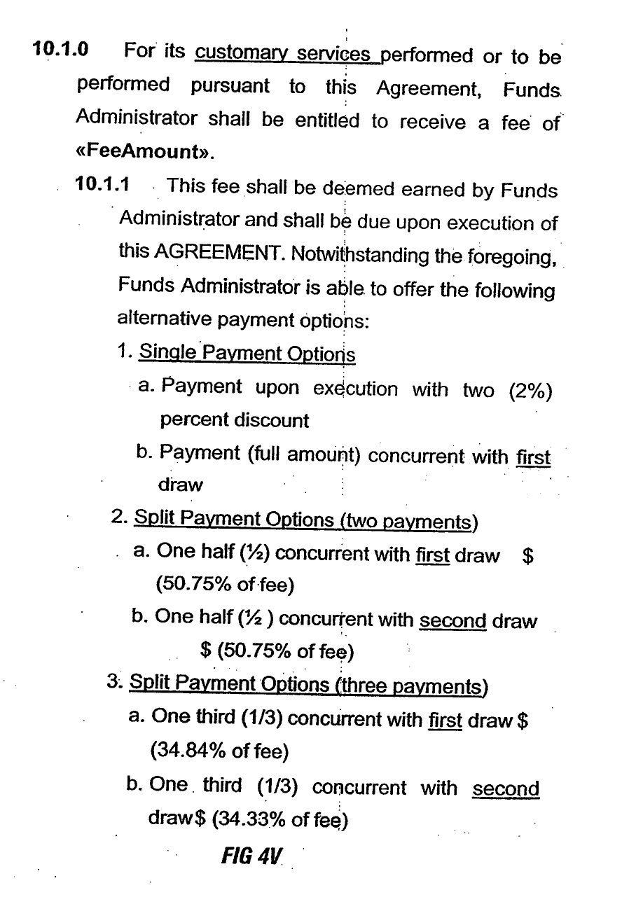

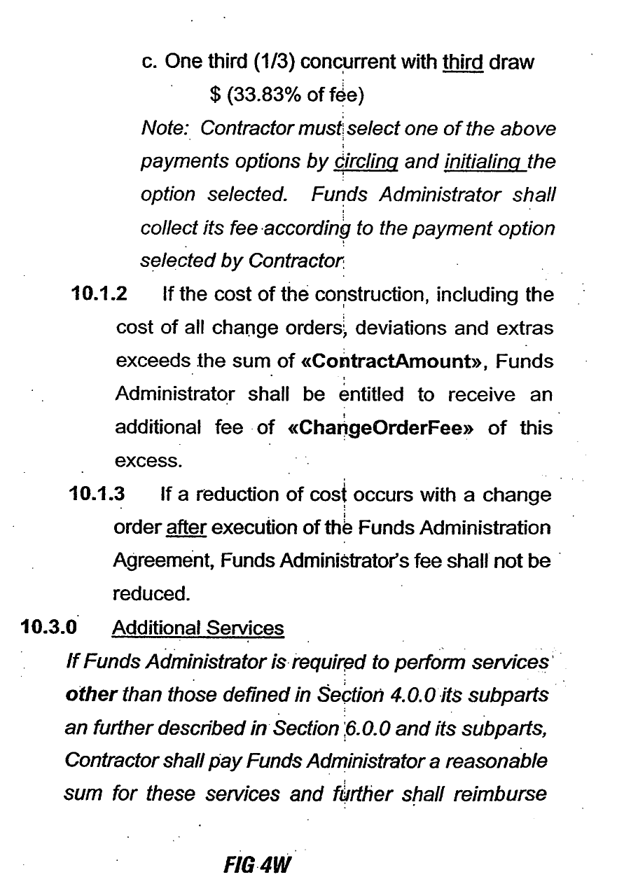

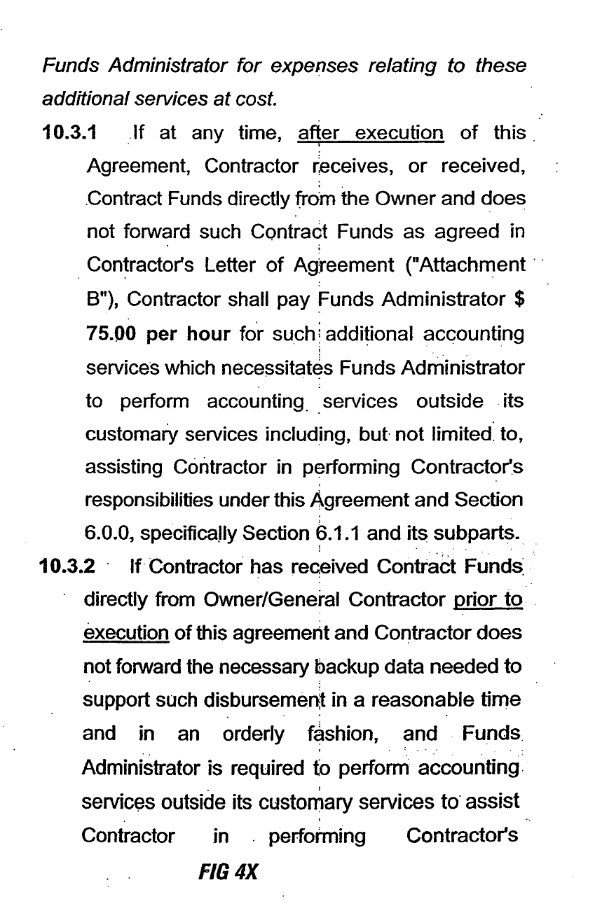

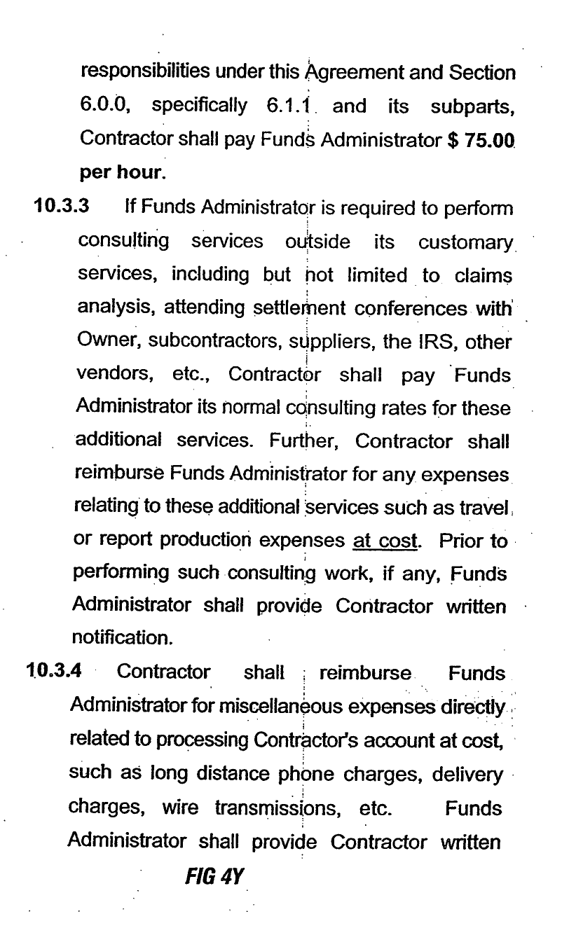

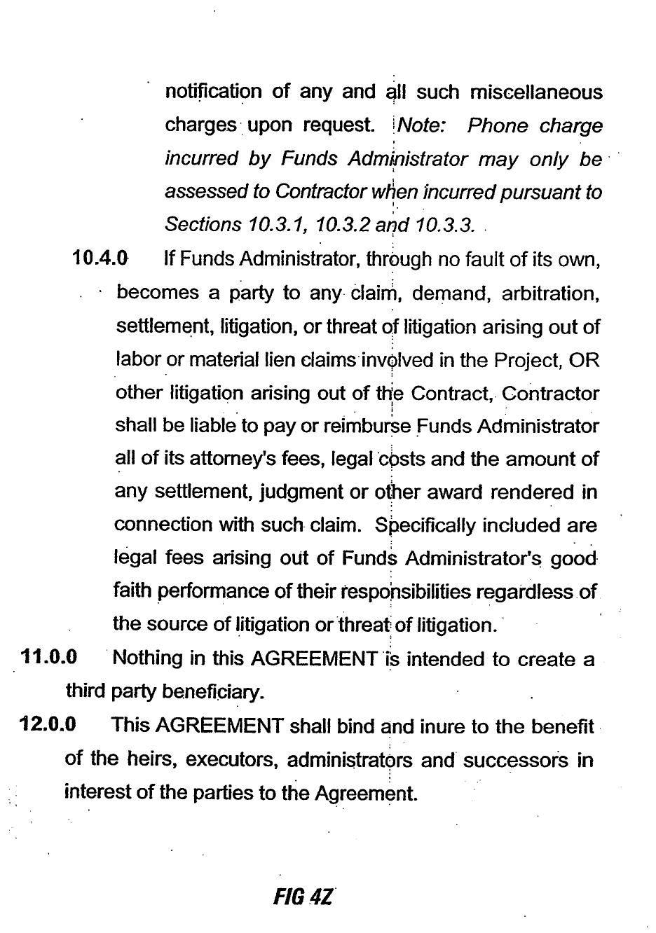

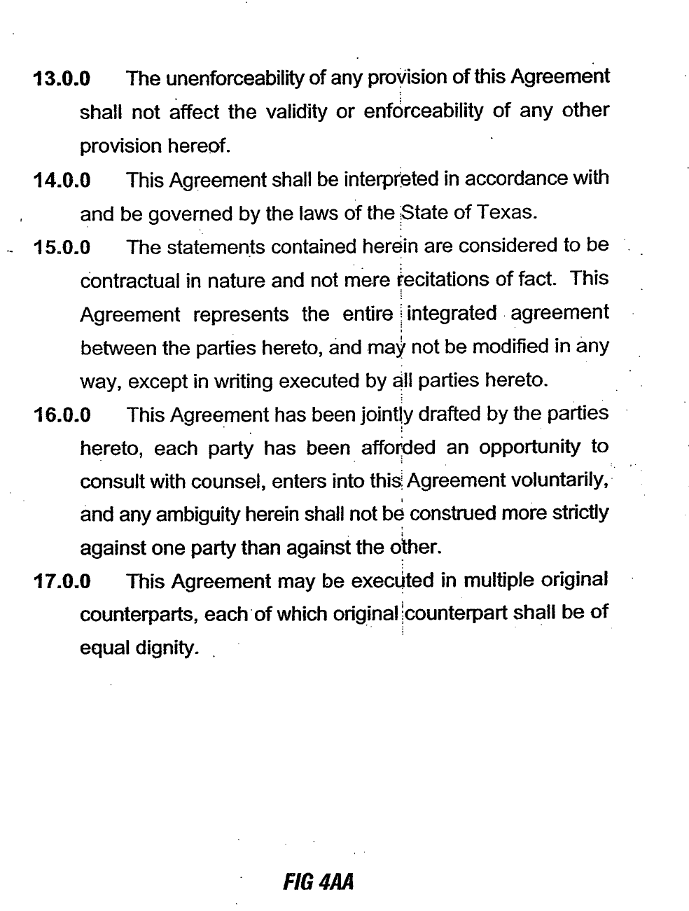

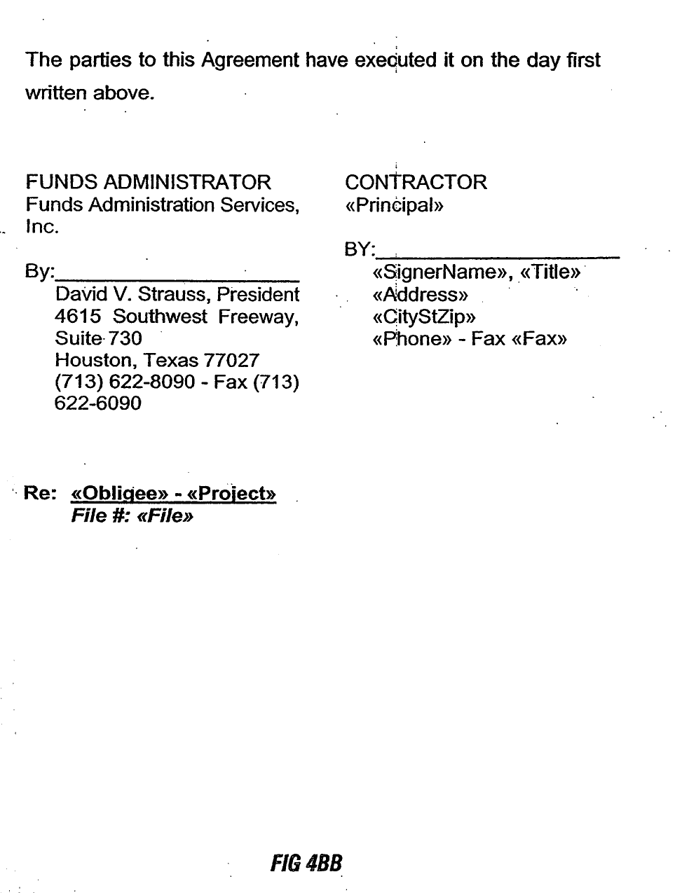

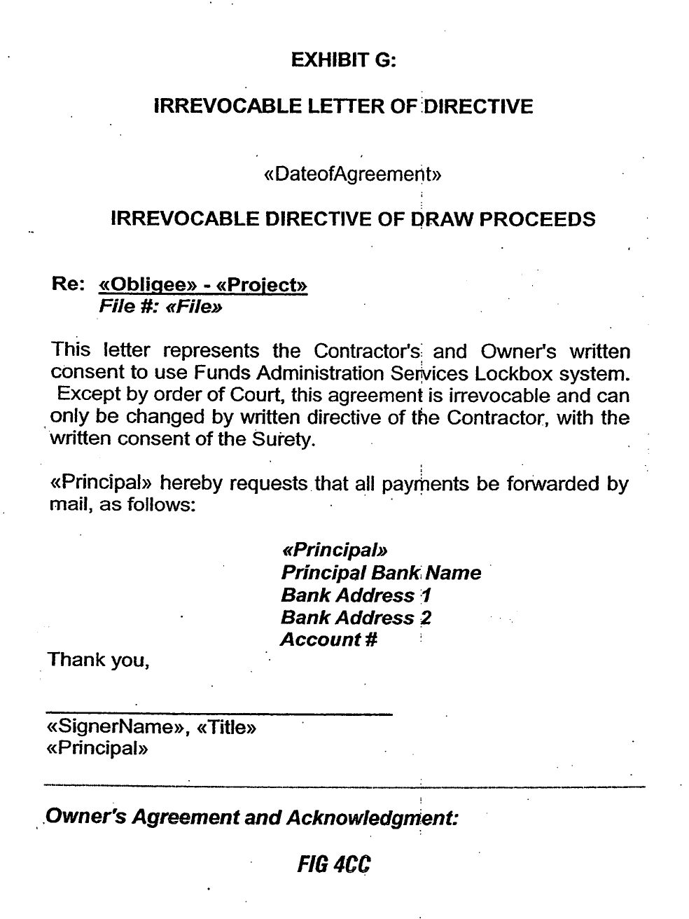

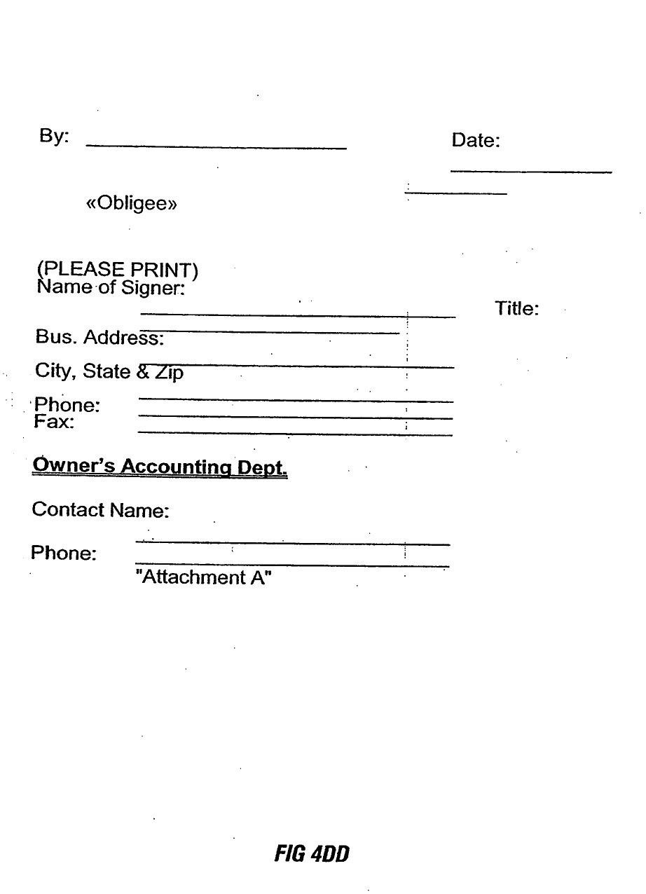

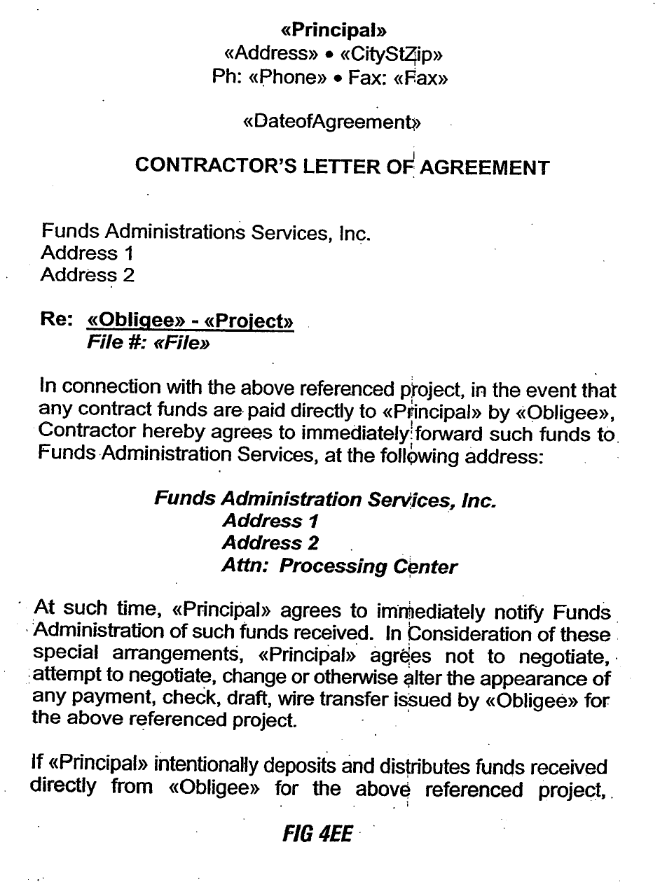

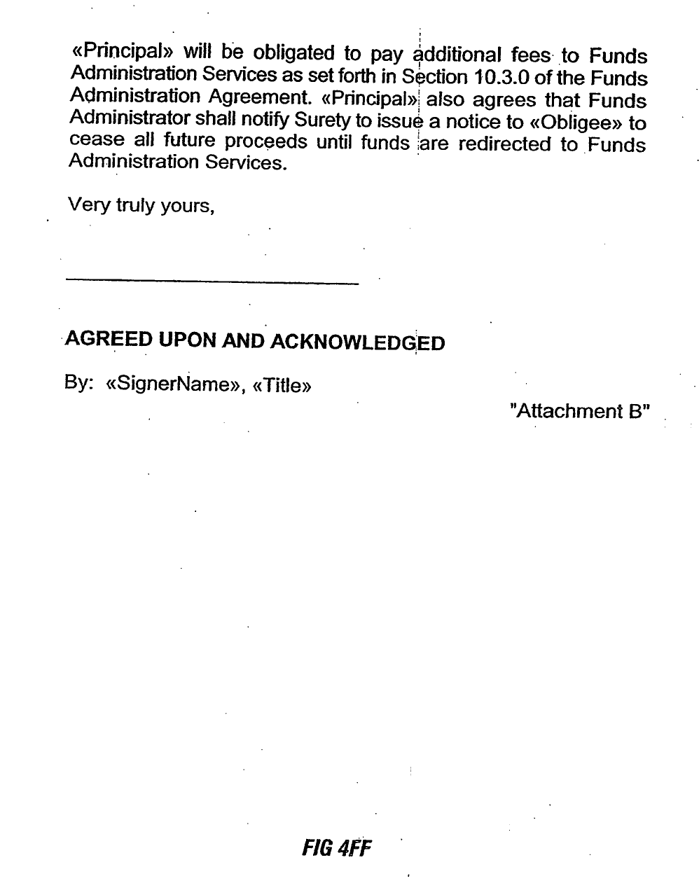

With further reference to FIG. 3, after the Construction Contract and the Funds Control Agreement (See FIG. 4) are executed by the parties, the Harmony Construction Loan Process according to the claimed subject matter can be fully implemented. One skilled in the art will also recognize that funds control is not just limited to the Contractor 101. As depicted in FIG. 3, the Owner 102 may or may not be subject to funds control, but in any case consents to the engagement of the Funds Control Administrator to distribute funds according to a Funds Control Agreement. During the course of the Construction Contract, the Contractor 101 completes the various tasks or milestones pursuant to the terms of the Construction Contract and according to the pre-established Schedule of Values. The Contractor 101 submits a Pay Request 105 to the Owner 102 for payment and forwards the necessary backup data 106 for the Pay Request 105 to the Funds Control Administrator 104 for processing. If the Funds Control Administrator 104 determines that the backup data 106 is incomplete or is lacking 116, it is returned to the Contractor 101 for completion and/or correction 108. The Owner 102 or its representative processes the Contractor's Pay Request by reviewing the request 123 and determines whether it meets the requirements of the Construction Contract, and if it does not, then the Owner 102 will reject the Pay Request 118 and will return the Pay Request to the Contractor 120. If the Contractor's 101 Pay Request meets the requirements of the Construction Contract then the Owner 102 approves the Pay Request for payment 110. The Owner 102 then transmits the Pay Request to the Lender 103 for payment. Pursuant to the Funds Control Agreement (See FIG. 4), the Lender 103 sends the funds 112 to Funds Control Administrator (sometimes also known as construction risk manager) 104 for processing the payment. If the Contractor 101 has complied with the provisions of the Funds Control Agreement by inter alia providing the necessary and complete backup data for the Pay Request then the Funds Control Administrator 104 will distribute the funds to the Contractor 122 for retention or distribution to subcontractors, suppliers, venders, etc. 114. It may be possible that the Owner 102 may approve the Pay Request 110, but upon review by the Lender 103, the Lender 103 may reject the pay request 126 for some reason (e.g., error in amount, typo in request) and thus the request is reviewed by the Owner 102 for possible correction.

Incremental site inspections 127 are performed from time to time, usually monthly, by the design professional to reasonably assure that the project is being built to the intent of the plans and specifications. Reports 129 are sent directly to owner, lender and construction risk manger/funds administrator 104.

Incremental site observations (not shown) are performed from time to time as a required element for the contractor to request and the developer/lender to advance incremental payments, typically using a pay application form, for work in place. These observations occur usually monthly, by someone qualified to perform such observations for the following purposes:
Determine whether the work in place has been performed in a workman like manner.
Determine a reasonable percentage of completion for each work item as listed on the schedule of values.
The individual performing the site observation is to generally photo document the project noting specific areas of concern.
Review and document materials stored for future incorporation into the project.
Report in writing to the construction risk manager, funds administrator who will forward to the developer/borrower and the lender.

Construction risk manager/funds administrator 104 performs from time to time in conjunction with submittal of the pay application by the contractor & borrower. The process includes the following elements:
Review of the site observation report for problem area which, if any, are to be reported to the lender; recognize percent complete by line item from the pay application and as verified during the site observation.
Review documents received from the contractor and/or developer/borrower including: foundation endorsement (engineer statement that the foundation is properly located on the construction site); Title Insurance Endorsement (from a title company stating that there have been no liens filed on the project); Check Request presenting desired payments along with supporting invoices from contractor, subcontractors and vendors having preformed work or providing materials or services on the project during the period subsequent to the previous pay period; review of lien releases from prior payments to contractor, subcontractors or vendors; Borrower authorization for disbursement enabling the lender to advance funds from the loan; With the aforementioned done, and after taking retainage requirements into account, a request for funding is made to the lender, and upon receipt of funds checks are issued to contractor, subcontractors and vendors to fulfill their requests for funding as reviewed and authorized by the Construction risk manager/funds administrator.
   Upon Completion—
   Receive Notice of Completion, Certificate of Occupancy, Contractor's Affidavit of Completion and Payment of Bills and Indemnity.
   With the aforementioned done, a request for final funding is made to the lender, and upon receipt of funds checks are issued to contractor, subcontractors and vendors to fulfill their requests for retainage funding as reviewed and authorized by the Construction risk manager/funds administrator.

With reference to FIGS. 4A-4FF, a preferred embodiment of the Funds Control Agreement is illustrated. While the preferred Funds Control Agreement includes provisions to execute payment and performance bonds pursuant to Section 2.1.0 via a Surety, one skilled in the art will recognize that sureties are typically required for projects in the public sector whereas Lenders, such as banks, are used in place of the surety for private construction contracts. In Section 3.0.0, the Contractor 101 warrants and certifies that it is properly licensed and has all permits required to complete the construction project. The Contractor 101 further agrees in Section 4.0 that the Funds Control Administrator 104 shall receive and disburse all funds paid by the Owner 102 to the Contractor 101 for work performed under the Construction Contract. In Section 5.0.0, the Funds Control Agreement provides for the Funds Control Administrator 104 to provide a contract specific commercial payment account for the purpose of receiving and disbursing payments according to the Construction Contract. In Section 6.0.0, the Contractor 101 agrees to and authorizes the Funds Control Administrator 104 to hold all contract funds and to withhold all Billings in Excess of Cost that may occur during the course of the construction project. The Contractor 101 is directed to submit payment request vouchers to obtain payment for subcontracted work, labor, materials, etc. pursuant to Section 6.0.0. In Section 7.0.0, the Contractor 101 is required to provide the Funds Control Administrator 104 with copies of all contract related documents including the contract between the Contractor 101 and Owner 102 and associated appendices and schedules required to process the pay vouchers. In Section 8.0.0, the Funds Control Administrator's 104 responsibility is to administer the contract, pay the vouchers, disburse funds, and to notify the Surety or Lender 103 of default in the event that it occurs. In Section 9.0.0, Contractor 101 default is defmed and default includes but is not limited to Contractor 101 bankruptcy, transfer assignment or sale by the Contractor 101 of the Construction Contract, pre-completion termination, etc. The Funds Control Administrator's 104 compensation is detailed in Section 10.0.0. While certain percentages to be paid the Funds Control Administrator 104 are disclosed in Section 10.0.0, one skilled in the art will recognize that any number of payment arrangements can be negotiated without departing from the scope of the claimed subject matter. The remaining Sections 11 through 17 include standard contract provisions typically found in many agreements. Again, one skilled in the art will recognize that these provisions can be included, excluded, or supplemented without departing from the scope of the claimed subject matter.

With further reference to FIGS. 4CC-4DD, “Attachment A” to the Funds Control Agreement, an Irrevocable Directive of Draw Proceeds is illustrated. Again, while the Irrevocable Directive of Draw Proceeds is drafted for use on a construction contract involving a Surety, one skilled in the art will recognize that a similar Irrevocable Directive of Draw Proceeds can be drafted for a lender in a private Construction Contract. The Irrevocable Directive of Draw Proceeds is an agreement and acknowledgement by the Owner consenting to the use of a funds administration lock box system for the receipt of the funds to be distributed in accordance with the Construction Contract and pursuant to the Funds Control Agreement. FIGS. 4EE-4FF of the Funds Control Agreement is the Contractor's Letter Agreement, which requires the Contractor 101 to forward all funds to the Funds Control Administrator 104 for collection and distribution according to the Construction Contract and Funds Control Agreement.

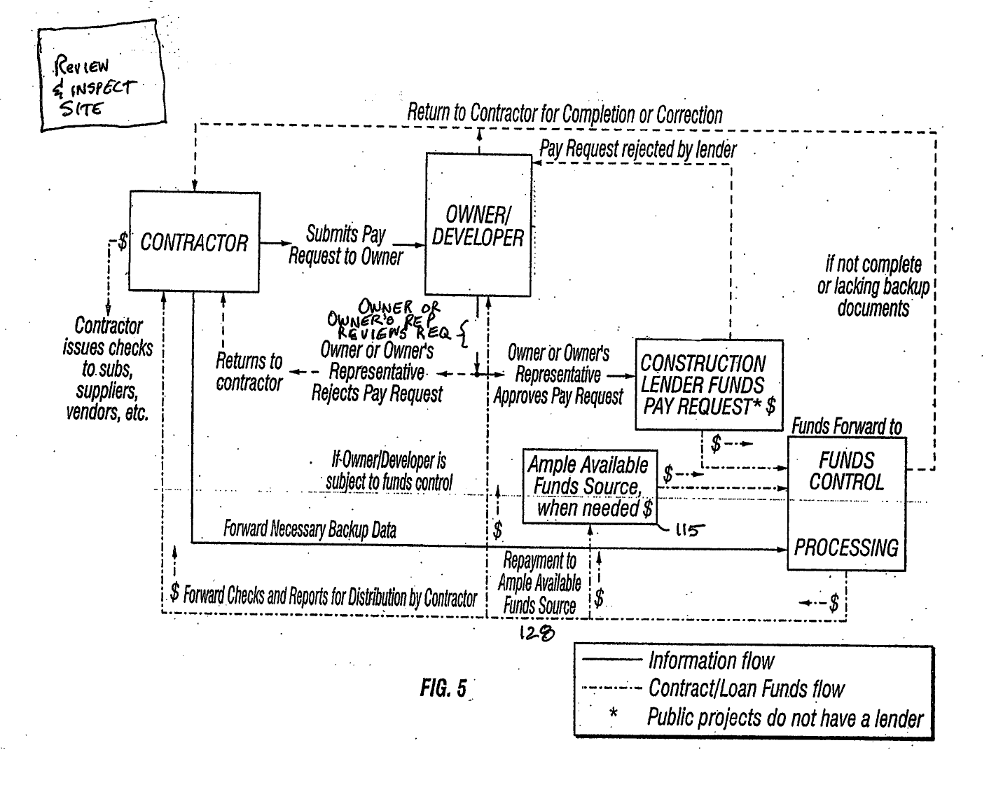

With reference to FIG. 5, the method and system are similar to FIG. 3, except a supplemental source of funds, Ample Available Funds Source 115, is depicted. This source of funds is depicted to identify a source of finding for special purposes such as initial mobilization and final demobilization from the project. According to the Harmony Construction Loan Process of the claimed subject matter, the Ample Available Fund Source 115 payments to the Funds Control Administrator 104 would also be subject to the Funds Control Agreement and Construction Contract terms and conditions. Should it be necessary, the Funds Control Administrator 104 can repay 128 the Ample Funds Source 115.

Finally, with reference to FIG. 6, the project cash flow is depicted according to the Harmony Construction Loan Process of the claimed subject matter. Unlike the cash flow depicted in FIG. 2, the cash flow depicted in FIG. 6 clearly shows that as the project funds are distributed throughout the course of the construction project, the project costs curve does not rise above the contractor profit and project revenue. curves when the Harmony Construction Loan Process of the claimed subject matter is utilized. Below are illustrative examples of the claimed subject matter.

### EXAMPLE 1

A local bank has become disenchanted with one of their long time borrowers. As graphically demonstrated on the Typical Project Cash Flow (See FIG. 2), project funds are typically paid for past work performed. This well tested process leads to misuses and abuses of project funds. The bank has agreed to loan 80% of the construction cost. The borrower is to fund 20% of the construction cost. Each project ends with the relatively powerless lender refereeing as the borrower and their contractor enter into significant negotiations, if not lawsuits, resulting from the payment, or non-payment, habits of the borrower. The lender is painfully aware of the abuses inherent in the typical construction loan process but heretofore has been somewhat powerless to control the situation. The borrower is trying to minimize their investment at the expense of the contractor.

In Response the Harmony Construction Loan Process is employed to provide a unique easy to use, alternative funding process. The project is provided funding from a source or multiple sources, in an amount equal to the funding needs of the project when needed, not before or not later. A funds administration process manages the project “source of funds ” and pays “valid uses of funds”.

By utilizing the Harmony Construction Loan Process, the borrower's funds and the lender funds are managed through funds administration pursuant to a Funds Control agreement system to facilitate prompt project payments. Funding abuses are minimized, if not eliminated, as the Funds Control Administrator ensures that project revenues go to pay obligations. The borrower does not handle the borrowed funds, thereby eliminating

### EXAMPLE 2

Nationwide large numbers of small businesses of all types engage in construction of facilities. Since these business owners can qualify for SBA loan guarantees, many lenders aggressively pursue these loans. SBA loans are typically 80% loan to value loans. In other words the borrower is required to invest 20% in the transaction. SBA types of projects include small hotels, oil change facilities, fast food franchises, car washes, etc.

SBA borrowers are generally not construction and development experts. Many are engaging in construction for the first time. Timely completion of the construction project is crucial to the initial success of the underlying venture.

Well managed construction activity allows the borrower (generally the business operator) to focus on managing his business which is traditionally his core competency. there is a direct relationship between how promptly payment is made to contractors, subcontractors, and vendors. Further, both the speed of construction and quality of workmanship are enhanced. Additionally, this eliminates, or greatly minimizes, disputes during and a completion of construction. Day to day management of these projects by a lender can be time consuming and unprofitable.

Employing a third party funds administrator pursuant to the Harmony Construction Loan Process minimizes the lender's level of day to day management and provides a high quality third party reporting to address compliance reporting requirements. This reporting facilitates quick project closeout and funding abuses are eliminated.

The present invention can generally be implemented using hardware (e.g., PC) and software (accounting software and spreadsheet, e.g., American Contractor and MS Excel, respectively).

By utilizing the claimed subject matter, the project funds, both loan proceeds from the lender and borrower funds, may be managed through funds administration system. This facilitates prompt project payments and quick problem resolution answering lender and borrower concerns. The foregoing invention has been described in terms of preferred embodiments. However, those of skill in the art will recognize that many variations of such embodiments exist. Such variations are intended to be within the scope of the claimed subject matter and the appended claims.

What is claimed is:

1. A method of controlling project fund distribution, comprising the steps of:
providing funds from a funds source, wherein the funds source delivers the funds to a funds control manager;
providing a funds control system managed by the manager;
analyzing pay requests according to the funds control system; and
distributing the funds according to the funds control system.

2. The method of claim 1, further comprising the steps of:
submitting backup data to the funds control manager;
submitting a pay request to an owner; and
analyzing the pay request by the owner.

3. The method of claim 2, further comprising the step of:
submitting a pay request to the funds source.

4. The method of claim 1, wherein the step of distributing the available funds according to the funds control system comprises the steps of:
forwarding payments and reports to a contractor; and
releasing payments to subs, suppliers and vendors.

5. The method of claim 1, wherein the funds control system comprises a funds control agreement entered into by the funds control manager, contractor and owner.

6. The method of claim 5, wherein the funds control agreement comprises the steps of:
instructions to distribute funds to pay contract obligations;
instructions to distribute funds to pay contractor overhead and profit;
instructions designating a distribution priority for funds; and
a mechanism to ensure that the funds are distributed according to the funds control system.

7. The method of claim 6, wherein the mechanism comprises an irrevocable letter of directive.

8. The method of claim 6, wherein the funds control agreement further comprises:
an irrevocable directive of draw proceeds; and
a contractors letter of agreement.

9. The method of claim 8, wherein the irrevocable directive of draw proceeds comprises an agreement between the contractor and the owner directing the source to distribute all funds to the funds control manager for distribution.

10. The method of claim 8, wherein the contractors letter of agreement comprises an agreement to direct funds not distributed by the source to the funds control manager to the funds control manager.

11. A construction loan process for managing the distribution of construction funding on a construction project, comprising the steps of:
providing a construction fund, wherein the construction fund is administered by a funds control manager;
providing a funds control system managed by the funds control manager by agreement of a project team;
determining whether funds should be distributed according to the funds control system; and
distributing the available funds according to the funds control system.

12. The process of claim 11, further comprising the steps of:
submitting backup data to the funds control manager;
submitting a pay request to an owner; and
analyzing the pay request by the owner.

13. The method of claim 12, further comprising the step of:
submitting a pay request to a construction lender.

14. The method of claim 11, wherein the step of distributing the available funds according to the funds control system comprises the steps of:
forwarding payments and reports to a contractor; and
releasing payments to subs, suppliers and vendors.

15. The method of claim 11, wherein the funds control system comprises a funds control agreement entered into by the funds control manager, contractor and owner.

16. The method of claim 15, wherein the funds control agreement comprises:
instructions to distribute funds to pay contract obligations;
instructions to distribute funds to pay contractor overhead and profit;
instructions designating a distribution priority for funds; and
a mechanism to ensure that the funds are distributed according to the funds control system.

17. The method of claim 16, wherein the mechanism comprises an irrevocable letter of directive.

18. The method of claim 16, wherein the funds control agreement further comprises:
an irrevocable directive of draw proceeds; and
a contractors letter of agreement.

19. The method of claim 18, wherein the irrevocable directive of draw proceeds comprises an agreement between the contractor and the owner directing the source to distribute all funds to the funds control manager for distribution.

20. The method of claim 18, wherein the contractors letter of agreement comprises an agreement to direct funds not distributed by the source to the funds control manager to the funds control manager.

21. A system for managing the distribution of construction funding on a construction project, comprising:
a funds control system managed by a funds control manager; and
a construction fund, wherein the construction fund is administered by the funds control manager.

22. The system of claim 21, wherein the funds control system comprises:
a funds control agreement between a contractor, project owner, lender, and the funds control manager, wherein said funds control agreement comprises:
a provision to pay contractor obligations;
a provision to pay contractor overhead and profit;
a provision to prioritize payments from the construction fund; and
a provision granting control of the distribution of payments from the construction fund to the funds control manager.

23. The system of claim 22, wherein the construction fund is selected from the group consisting of a lender construction loan, an owner construction loan, and a mobilization loan.

24. The system of claim 21, wherein the funds control system comprises a funds control agreement entered into by the funds control manager, contractor and owner.

25. The system of claim 24, wherein the funds control agreement comprises:
instructions to distribute funds to pay contract obligations;
instructions to distribute funds to pay contractor overhead and profit;
instructions designating a distribution priority for funds; and
a mechanism to ensure that the funds are distributed according to the funds control system.

26. The system of claim 24, wherein the funds control system further comprises an irrevocable letter of directive.

27. The system of claim 25, wherein the funds control agreement further comprises:
an irrevocable directive of draw proceeds; and
a contractors letter of agreement.

28. The system of claim 27, wherein the irrevocable directive of draw proceeds comprises an agreement between the contractor and the owner directing the source to distribute all funds to the funds control manager for distribution.

29. The method of claim 27, wherein the contractors letter of agreement comprises an agreement to direct funds not distributed by the source to the funds control manager to the funds control manager.

30. The method of claim 27, wherein the contractors letter of agreement comprises an agreement to direct funds not distributed by the source to the funds control manager to the funds control manager.
